(19) United States
(12) Patent Application Publication
(10) Pub. No.: US 2004/0105398 A1
(43) Pub. Date: Jun. 3, 2004

(54) Method and electronic switching circuit for a scalable communication interface in automation components

(76) Inventors: Michael Franke, Erlangen-Dechsendorf (DE); Martin Kiesel, Poxdorf (DE)

Correspondence Address: HENRY M FEIEREISEN, LLC, 350 FIFTH AVENUE, SUITE 4714, NEW YORK, NY, 10118, US

(21) Appl. No.: 10/471,652

(22) PCT Filed: Mar. 11, 2002
(86) PCT No.: PCT/DE02/00852

(30) Foreign Application Priority Data
Mar. 22, 2001 (DE) 101 14 389.3
Sep. 26, 2001 (DE) 101 47 432.6

(51) Int. Cl. H04L 5/22

(52) U.S. Cl. 370/299

(57) ABSTRACT

The invention relates to a method and an electronic switching circuit for a scalable communication interface between a first communication connection (16) having a first transmission cycle (17) of a first length, and a second communication connection (12) having a second transmission cycle (13) of a second length, comprising a receive list (5), (7), (15), (19) for the first transmission cycle and a send list (4), (6), (14), (18) for the second transmission cycle, a data telegram (2), (21), (22), (23), (24), (25), (26), (27), (28) received according to the receive list being associated with an element of the send list.

The invention relates to a method and an electronic switching circuit for producing a communication interface, in particular in an automation system.

Different methods and systems for producing communication links between stations of a data networks are known in the state-of-the-art. Bus systems are widely used, wherein each station can address any other station of the data network directly via the bus system. In addition, switchable data networks are known where so-called point-to-point-connections are established, i.e., a station can reach all stations of this switchable data network only indirectly, by transferring the data to be transmitted via one or several coupling units.

Data networks enable the communication between several stations through networking, meaning by connecting the individual stations with each other. Communication refers to the transmission of data between the stations. The data to be transmitted are sent as data messages, i.e., are assembled into the one or more packets and sent over the data network to the corresponding recipient. These are also referred to as data packets. The term transmission of data is used synonymously with the above-mentioned transmission of data messages or data packets.

Networking itself is enabled, for example, by using switchable high-performance data networks, in particular the Ethernet. At least one coupling unit is inserted between two stations connecting both stations. Each coupling unit can be connected to more than two stations. Each station is connected with at least one coupling unit, but is not connected directly with another station. Stations are, for example, computers, memory-programmable controllers (MPC) or other machines which exchange, in particular process, electronic data.

In distributed automation systems employed, for example, in the field of drive technology, certain data have to be received at specified times by certain stations and processed by the recipients. These are referred to as real-time critical data or data traffic, since data not timely received at the destination can lead to undesirable results at the destination station.

It is also known in the state-of-the-art to use in an automation system of this type a synchronously clocked communication system with equidistant characteristics. This refers to a system with at least two stations which are connected via a data network for the purpose of exchanging data and/or for bidirectional transmission of data.

The data exchange is performed cyclically in equidistant communication cycles which are defined by the communication clock cycle used in the system. Stations are, for example, central automation devices, e.g., memory-programmable controllers (—MPC, motion controllers) or other control units, computers or machines which exchange electronic data with other machines, in particular process electronic data of other machines, and peripheral devices, such as input/output devices, actuators, sensors. Control units refer herein to regulating and control units of any type. For example, communication systems such as field bus, process field bus, Ethernet, industrial Ethernet, FireWire, as well as PC-internal bus systems (PCI) are used for data transmission.

Modern automation components (e.g. controllers, drives, . . . ) frequently include an interface with a cyclically clocked communication system. An execution plane of the automation component (fast cycle) (e.g., position control in a controller, rotation speed and torque control of a drive) is synchronized with the communication cycle. This defines the communication clock rate. Other, low-performance algorithms (Slow-Cycle) (e.g., temperature controls) of the automation component can also communicate with other components (e.g., binary switches for fans, pumps, . . . ) only at this communication clock rate, although a slower cycle would be sufficient. The bandwidth of the transmission path and the communication circuit of the components have to meet stringent performance requirements if only one communication clock cycle is used to transmit all information in the system.

In most cases, conventional system components use for communication for each process and/or automation plane a single cyclically clocked communication system or a single communication cycle (Fast-Cycle) during which all relevant information is transmitted. Data which are required only in Slow-Cycle, can be transmitted sequentially, for example, via additional protocols so as to limit the bandwidth requirements. This represents additional software expenses for the automation components. Moreover, the lowest performance component determines the bus bandwidth as well as the minimum possible communication cycle in the entire system.

It is therefore an object of the invention to provide an improved method and an improved electronic circuit for a communication interface as well as a corresponding computer program product.

The object of the invention is solved by the corresponding features of the independent claims.

The invention permits the implementation of a communication interface between differently performing cyclically clocked communication links. With this arrangement, the invention enables, for example, the operation of differently performing communication links whose characteristic is adapted to the corresponding application, for example, in an automation system. For example, the invention can provide a low-performance communication interface for slow input/output devices, so that the devices can communicate via a corresponding interface with the associated execution plane in the controller.

According to a particular advantage of the invention, the communication interfaces can be scaled according to different criteria, in particular according to:

scaling with respect to real-time operation of communication interfaces with applications for:

standard Ethernet with standard protocols (TCP/IP), Soft Real-Time Ethernet (SRTE)— this refers to a real-time-capable of Ethernet where the real-time functionality is implemented without “fancy” hardware components by suitable software or where essential parts of the real-time capability are implemented by software and other functional components are implemented by an Application Specific Integrated Circuit (ASIC). Such SRTE is characterized by a relatively low synchronization clock rate and by communication cycles in the range of preferably between 3 ms and 10 ms. The real-time capability can be implemented with corresponding software and/or ASIC functionality based on standard Ethernet components.

Isochronous Real-Time Ethernet (IRTE)— this refers to a communication system based on Ethernet technology which permits within a communication cycle, the so-called isochronous cycle, both the transmission of real-time critical data as well as non-real-time critical data. The plannable real-time communication is separated from the non-plannable, non-real-time-critical communication by using the method for time synchronization disclosed in the unpublished application DE 100 04 425.5. IRTE is characterized by a relatively high synchronization clock rate of, for example, one microsecond and by relatively short deterministic communication cycles with transmission of real-time data about, e.g., communication cycles of 125 μs to 10 ms. The real-time functionality is implemented via software and by corresponding “fancy” hardware components, e.g., so-called switches, hubs and integrated switches.

scaling with respect to possible transmission rates (Bd=Baud)

e.g., 10 MBd, 100 MBd, 1 GBd

scaling with respect to the transmission rate for including qualitatively different automation components, e.g.

100 MBd Isochronous Real-Time Ethernet connections for synchronized drives and fast I/O and

e.g., 10 MBd connections for connecting to a peripheral device with camera system or barcode reader

e.g., 100 MBd standard Ethernet connection for connecting to a control system, engineering system and/or the Internet.

scaling with respect to the relationship between the communication interfaces

synchronized with the same cycle

synchronized with stepped-down cycle

mutually synchronized fast and slow cycles (one interface “fast”, one interface “slow”)

consistent data exchange between the communication interfaces

routing between communication interfaces at different quality levels

redundancy:

data transmission via disjoint paths

clock cycle transmission via disjoint paths

scaling with respect to the relationship between the communication interfaces and the applications executed on the automation components

fast and slow applications, which are synchronized with the fast and slow cycles

scaling with respect to connectable devices

ES, OP, control system, Internet via extended Ethernet

components with isochronous real-time Ethernet characteristics

components with soft real-time Ethernet characteristics

sensor/actuators (e.g., I/O, drives, cameras, barcode readers, transmitters) with different baud rates (e.g., 10 MBd, 100 MBd)

According to another advantageous feature of the invention, as a result of this scalability, the available, clocked, physically separate transmission cycles can be coupled to or associated with the respective application cycles. This makes it possible to adapt the communication to the requirements of parts of the application, so that the highest application demand of the automation system does not determine the communication performance for all components of the system.

According to another advantageous feature of the invention, a coupling node no longer requires the existence of several separate interfaces for coupling the different performing networks, as is the case in the present state-of the-art. As a result of the hardware implementation of the communication interface made possible by the invention, the data can be more quickly coupled in or out of different segments.

For various reasons, in decentralized systems different communication cycles are required between different nodes (for the same transmission rate of, e.g., 100 Mbit/sec with the isochronous real-time fast Ethernet), whereby nodes—so-called coupling nodes—exist that have to communicate simultaneously with nodes that use different communication cycles.

A preferred embodiment of the invention relates, inter alia, to a communication circuit (switch ASIC), which includes several separate communication links (Ports). The communication via different links can also occur synchronously during a communication cycle that is identical for all the ports.

The invention further relates to a mechanism which enables different communication cycles (integer multiples of the shortest communication cycle) at the different ports. This enables a synchronized and consistent data exchange between nodes operating with different communication cycles. The synchronized data exchange can occur

either by a direct transfer of the messages, when real-time data are exchanged at the receive and target port in the communication cycle, or

by intermediately buffering in a common memory, meaning that the data are always written to the intermediate buffer from the receive port. The data are sent from the intermediate buffer by the send port at the equivalent send time.

Each port includes send and receive lists which control sending, transfer and receipt of data. Since the intermediate ports have different communication cycles (integer multiples of the shortest communication cycle), the send and receive lists are frequently processed differently at the respective ports.

The data to be sent or received by one port are associated with the send and receive lists of another port at the communication interface or during communication setup.

In the communication interface, data can be received or sent over ports with a faster communication cycle as well as over ports with a slower communication cycle. A data message received and to be transmitted is associated at the communication interface with a transmission cycle of the ports from which the data message is to be sent.

Data which are to be sent from a port with a slower communication cycle via a port with a faster communication cycle have to be either

intermediately stored so that valid data can be sent even during the cycle when no data are received over the port with the slower communication cycle, and/or

data indicated to be invalid or data that have arrived during the last cycle are repeatedly sent via the port with the faster communication cycle during the time when no data arrive via the port with the slower communication cycle.

The advantage is, inter alia, that

a) only one (standard) communication interface has to be implemented on a coupling node, and

b) no additional instance is required for copying the data between the different communication interfaces which, in particular, results in no dead times at all or only short dead times.

The invention also makes it possible to couple differently performing sub-networks with each other. The so-called isochronous cycles of the different sub-networks can be different.

In a preferred embodiment of the invention, a communication connection is established using a so-called Switch-ASIC which includes separate inputs, outputs (ports) for the different communication links. According to the state of the art, the communication occurs via different links synchronously in a communication cycle and at a transmission rate which is the same for all ports. The invention enables, on the other hand, different transmission rates and/or different communication cycles on the different ports. This allows a consistent data exchange between different nodes, for example, via a so-called coupling field of the Switch-ASIC's using different transmission rates and/or different communication cycle.

The consistent data exchange can occur via an intermediate buffer in a common memory, i.e., the data from the receive port are always written into the common intermediate buffer. The data are sent at the corresponding send time by the send port from the intermediate buffer.

To ensure data consistency, an additional send and receive buffer with a size corresponding to the maximum number of messages can be provided at each port.

According to a preferred embodiment of the invention, the data are copied into the common intermediate buffer after the complete message has been received at the receive port—so-called store-and-forward method. During a send operation, the data are always copied from the intermediate buffer into the send buffer of the send port. An access control for the common intermediate memory ensures that data in the intermediate buffer cannot be overwritten during read and write operations. Alternatively, for example, a so-called cut-through process can be used.

According to another advantageous feature of the invention, an automation system with differently performing sub-networks can be implemented, in particular for application including packing machines, presses, plastic injection machines, textile machines, printing presses, machine tools, robots, handling systems, wood processed machines, glass processing machines, ceramic processing machines, as well as lifting gear.

A preferred embodiment of the invention will be described in more detail hereinafter with reference to the drawings. It is shown in:

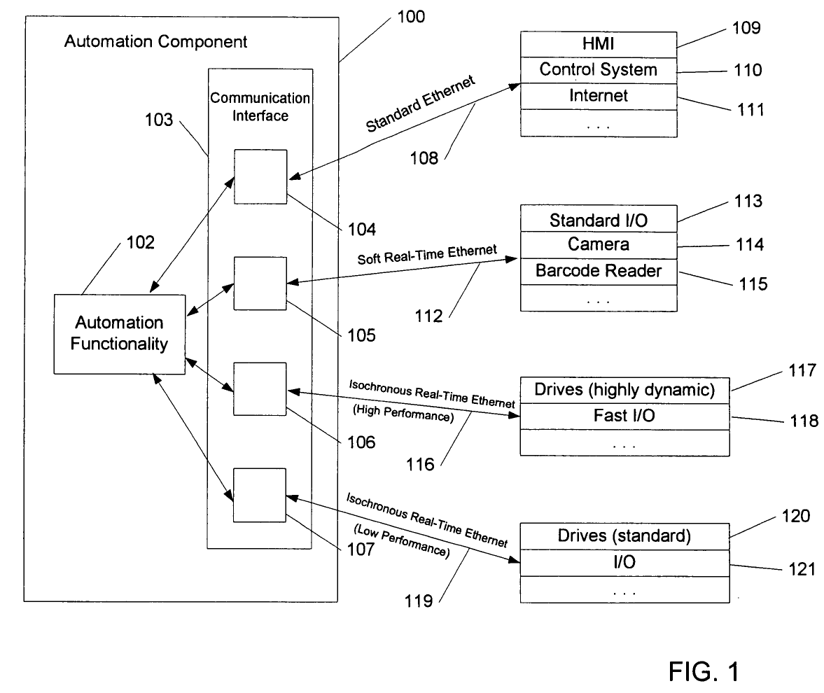

FIG. 1 a block diagram of an automation component which includes an embodiment of a communication interface according to the invention,

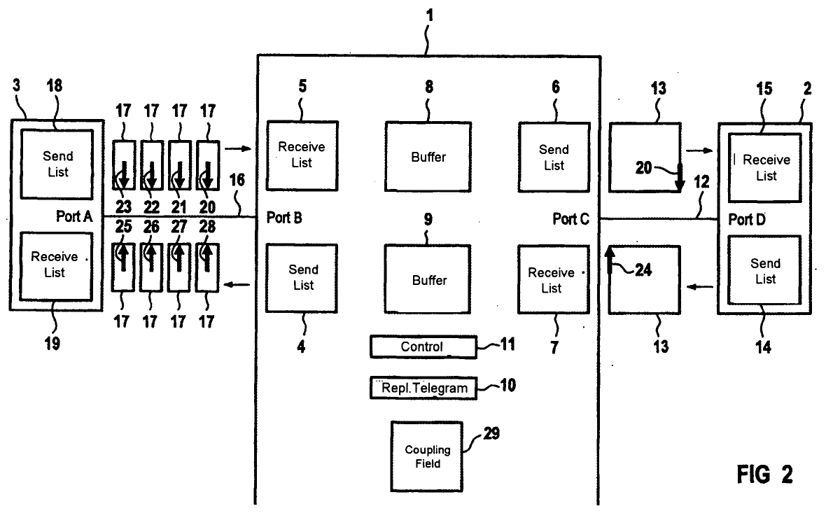

FIG. 2 a block diagram of an embodiment of an electronic circuit according to the invention and corresponding communication links between two stations of differently performing networks,

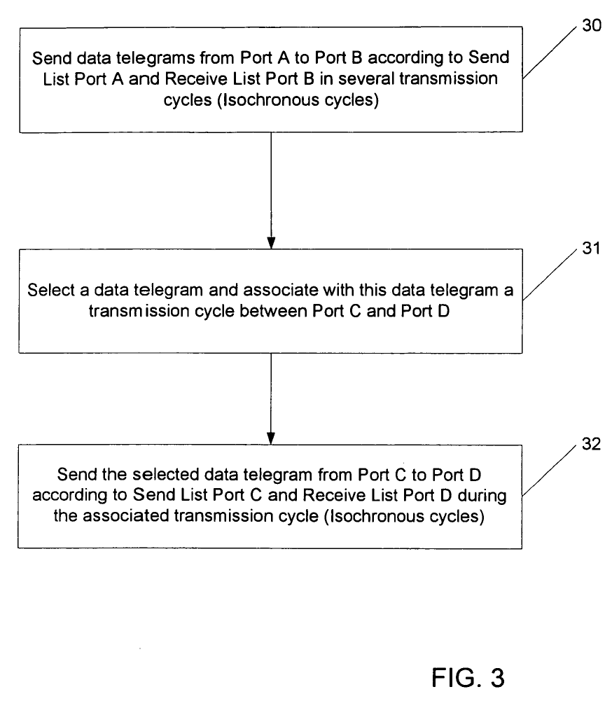

FIG. 3 a flow diagram the first preferred embodiment of the method of the invention,

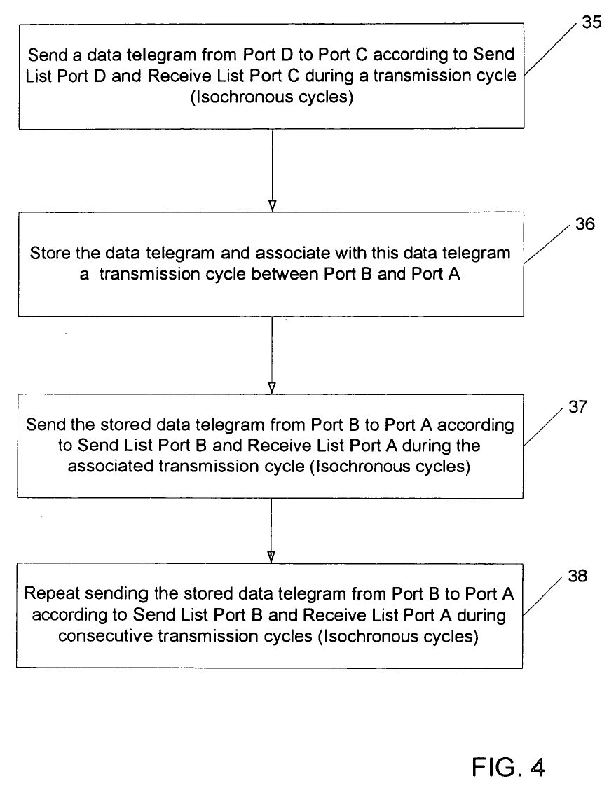

FIG. 4 a flow diagram of a second preferred embodiment related to sending a data message from a low-performance network to a higher-performance network,

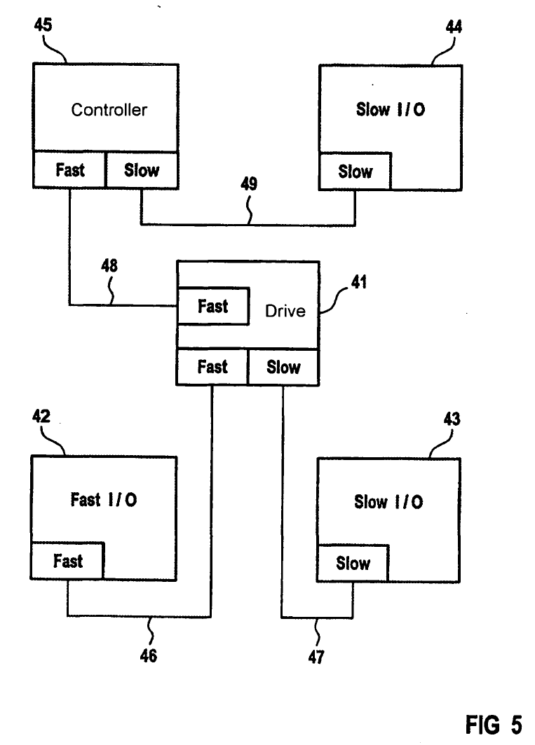

FIG. 5 a preferred embodiment of the automation system according to the invention,

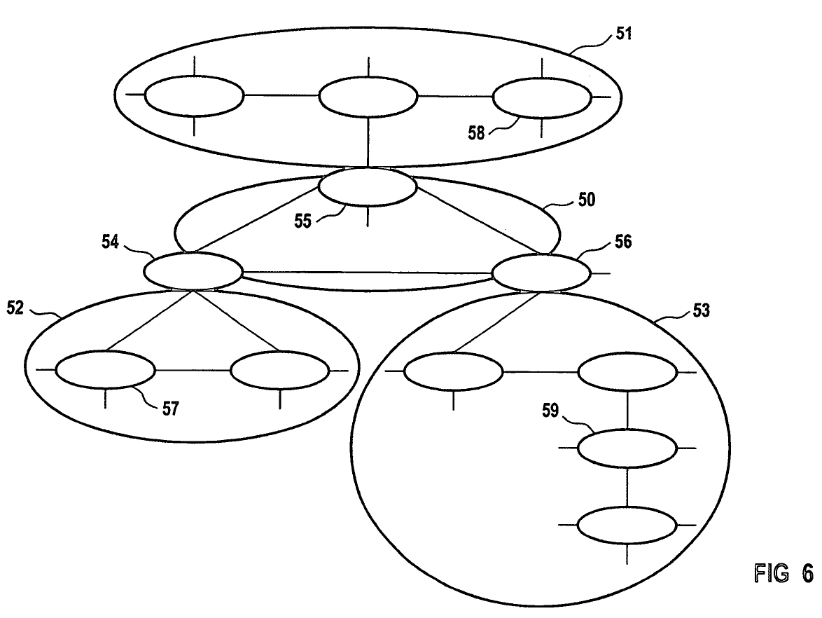

FIG. 6 an embodiment of an automation system with differently performing sub-networks.

FIG. 1 shows an automation component 100 with a controller 102. The controller 102 can be, for example, a so-called motion controller for controlling an assembly. For example, the controller 102 can be used to control different axes, drives and other assemblies of the assembly. The automation component 100 includes a communication interface 103 with communication ports 104, 105, 106 and 107.

The communication ports 104 to 107 are scalable. For example, the length of a communication and transmission cycle can be selected based on the system requirements. The properties of the respective communication ports 104 to 107 can be specified during the planning stage or can be defined by a plug-and-play mechanism when the device is connected to one of the communication ports 104 to 107.

The communication port 104 is connected via a communication link 108 with a Human-Machine-interface 109, a control system 110 and an Internet access 111. The communication link 108 is implemented as a standard Ethernet connection.

Conversely, the communication port 105 is scaled for a so-called Soft Real-Time Ethernet communication link 112. The communication port 105 communicates via the communication link 112, for example, with a standard Input/Output unit 113 (“Standard I/O”), a camera 114 as well as a barcode reader 115 and/or additional units or devices.

The communication port 106 is designed to connect with an Isochronous Real-Time Ethernet and configured for a high-performance communication link 116. The communication port 106 communicates via the high-performance Isochronous Real-Time Ethernet communication link 116 with a drive 117, which is highly dynamic, meaning that its controller requires a communication link with a relatively high bandwidth and a high sampling rate. The communication port 106 also communicates with the Input/Output unit 118 which is implemented as a “Fast I/O” and/or with additional units and devices.

The communication port 107 is also designed to connect with an Isochronous Real-Time Ethernet, wherein the communication port 107 is scaled for a low-performance Isochronous Real-Time Ethernet. The communication port 107 communicates via a corresponding communication link 119 of a low-performance Isochronous Real-Time Ethernet with a standard drive 120 and with a standard input/output unit 121 and/or with additional units and devices.

In the embodiment of FIG. 1, the communication interface 103 is advantageously integrated in the automation component 100, allowing the realization of several essentially identical communication interfaces. For example, the communication ports 104 to 107 can have a standardized connection technique for standardized cable media.

The performance and usage functionality of the communication interface 103 can be scaled. The scalability is expressed, inter alia, by a combination of the following characteristic properties:

The communication over one of the communication links 108, 112, 116 and 119 is always executed based on a standard protocol, e.g., TCP/IP over Ethernet.

Optionally, a communication link can be scaled as a real-time-capable or a non-real-time-capable communication link.

Different devices, which require a different performance of the communication link, can be connected to the automation component 100. For example, components that can be connected to a Soft Real-Time Ethernet communication port or to an Isochronous Real-Time Ethernet with real-time capability, or also components that require either a low-performance real-time capability or without any real-time capability.

The transmission rate or Baud rate can be scaled according to the requirements of the devices to be connected. Scaling can be accomplished by configuring the software of the communication interface 103, for example, during the planning stage of the automation system or by a plug-and-play mechanism.

A routing functionality is implemented between different communication interfaces 103 of an automation system. The communication interfaces preferably include a coupling field.

The communication interfaces can be synchronized which is of particular importance for real-time communication. Synchronous transmission cycles can hereby have the same length or different lengths, in which case the length of one transmission cycle is an integer multiple of the length of the other transmission cycle. This is particularly advantageous since the available synchronization resources can thereby be used effectively. For example, one controller in a facility can control twenty axes.

Six of the axes are highly dynamic and require a transmission cycle of 1 ms. The remaining fourteen axes are less time-critical and require a transmission cycle of, e.g., 4 ms or 8 ms. Each of the twenty axes has a sensor that acquires the actual position values of the axis at the respective clock rates.

These have to be transmitted with the corresponding clock rates to a communication interface. The scalability of the communication interface makes it possible to scale a first communication interface with a high performance for operating the six axes and to scale a second communication interface with a lower performance for controlling the fourteen less time-critical axes.

In this way, the computer power available to the controller is used efficiently and the entire controller need not be operated at the high clock frequency of 1 ms, as required with conventional systems.

According to the invention, a functional redundancy can be implemented by establishing redundant communication links by chaining point-to-point connections between the nodes of a network.

FIG. 2 shows an electronic circuit 1 which operates as coupling node between the nodes 2 and 3.

The coupling node 1 includes the two communication ports Port B and Port C. A send list 4 and a receive list 5 are associated with the Port B. The send list 4 determines in a deterministic communication system the point in time when data messages are to be sent to specified recipients from coupling node 1 to the recipient's Port B. Accordingly, the receive list 5 determines the data messages to be received at the Port B from the different nodes of the communication system at the different points in time. The manner, the point in time and the addressee of the data messages is hence determined in advance; only the useful data transported with their respective data messages change.

Port C has a corresponding send list 6 and a receive list 7 for data messages to be sent from or to be received by Port C.

The coupling node 1 also includes a buffer memory 8 for data messages received by Port B and/or to be transmitted by Port C as well as a buffer memory 9 for data messages received by Port C and/or to be transmitted by Port B. For example, the buffer memories 8 and 9 can be implemented by a common storage element or in the coupling field 29.

The coupling node 1 also includes a memory 10 for a replacement message as well as a controller 11 which can be implemented entirely or partially either as a circuit or in microcode.

The coupling node 1 is connected with the node 2 via a communication link 12. The communication link 12 is a low-performance link with a relatively low data rate and a relatively long transmission cycle 13 which is also referred to as frame.

The communication link 12 connects the Port C with a Port D of the node 2. A send list 14 and a receive list 15 is associated with the Port D, which also specifies the deterministic transmission of data messages near the communication system, i.e., via the communication link 12.

Likewise, the Port B of the coupling node 1 is connected with a Port A of the node 3 via a communication link 16, whereby the communication link 16 is a high-performance link with a relatively high data rate and a relatively short transmission cycle 17.

Associated with the Port A of the node 3 is again a send list 18 and a receive list 19 for the deterministic transmission of data messages from or to the node 3.

The communication over the communication links 12 and 16 is executed in the cyclically repeating transmission cycles 13 and 17, respectively, which themselves can be subdivided into time slots. During a transmission cycle 13 or 17, the corresponding receive and send lists are processed, whereby different data messages are associated with the corresponding timeslots during a transmission cycle. The illustrated example of FIG. 2 illustrates four consecutive transmission cycles 17 during each of which one or several data messages are transmitted. For the sake of clarity, only one data message 20, 21, 22 and 23 is shown in FIG. 2 for each transmission cycle 17.

Preferably, the communication links 12 and 16 are synchronized with each other, i.e., the start of the transmission cycles 16 and 17 does not have a mutual phase shift. The length of the transmission cycles 13 and 17 can be identical or—as in the depicted example—can be an integer multiple, i.e., the length of the transmission cycle 13 is an integer multiple of the transmission cycle 17.

In a first exemplary application, the data messages 20, 21, 22 and 23 are transmitted according to the send list 18 from the node 3 during to the transmission cycle 17 via the communication link 16 to the Port B of the coupling node 1. The data messages 20 to 23 each carry certain useful information, for example a rotation speed, if the node 3 represents a rotation speed sensor. The rotation speed sensor hence supplies in the deterministic system within each transmission cycle 17 a value to be transmitted. The corresponding transmission is defined in the send list 18 and in the corresponding receive list 5.

These data messages 20 to 23 are received in node 1 at the Port B according to the receive list 5 and can be intermediately stored in buffer memory 8. One of the data messages 20 to 23 is then selected in the coupling node 1, for example, by the controller 11 for transmission according to the send list 6 during the transmission cycle 16 of the communication link 12 from the Port C to the Port D of node 2.

In general, any data message of the data messages 20 to 23 can be selected—in the described embodiment, the data message of the transmission cycle 17 that is transmitted first is always selected—, in this case the data message 20. To send the data message 20, the Port C only has to access the buffer memory 8 to call up the data message 20 for transmission according to the send list 6. This mechanism is executed entirely in the hardware plane or in a hardware-related plane without the need to transform and/or reformat the data on a higher program-related plane.

For example, a step-down can be accomplished in this way, as is the case for the application depicted in FIG. 2, meaning that of the four data messages 20 to 23 only the data message 20 is transmitted onwardly.

If the measurement values in node 3 are acquired by so-called oversampling, i.e., for example with a sampling frequency that is greater by a factor of four or more than the so-called Shannon frequency, then this process is executed without loss of information.

In another exemplary application, a data message 24 is transmitted by the node 2 according to its send list 14 during the transmission cycle 14 via the communication link 12 from its Port D to the Port C of the coupling node 1 according to its receive list 7 and intermediately stored in buffer memory 9.

The coupling node 1 transmits according to its send list 4 from its Port B during the next transmission cycles 17 the data messages 25, 26, 27 and 28. This can be accomplished by making each of the data messages 25 to 28 a copy or a part of the data message 24. In this way, the requirements of the receive list 19 are met which expects a data message in each data slot of the transmission cycle 17.

Alternatively, a replacement message which does not carry useful information can be stored in memory 10. In this case, only one of the data messages 25 to 28 is a copy of the data message 24, for example the data message 25, whereas the other data messages 26 to 28 are each copies of the replacement message of memory 10. This process can be controlled, for example, by the controller 11.

In general, when a data message is transmitted n-times from node 3, for example by a fourfold transmission, this data message is transmitted from node 1 to the node 2 m-fold, whereby m<n, preferably m=1, as in the described example.

Conversely, if a data message is transmitted n-fold via the low-performance communication link 12, then this data message is either repeated m-fold, i.e., in the illustrated example there is a fourfold repeat with a single transmission, or the transmitted data message is only transmitted once and (m−1) replacement messages are transmitted in addition.

The coupling node 1 also has a coupling field 29 which can be used to establish in the coupling node 1 communication links between the Ports B and C as well as, if necessary, additional ports of the coupling node 1 which are not illustrated in FIG. 2.

The electronic circuit that forms the basis for the coupling node 1 can also be used for implementing a device interface, e.g., the device interface of a controller with communication links having a different performance. A coupling field is not required for this application.

FIG. 3 shows a corresponding flow diagram.

In step 30, a number of m data messages are initially transmitted from Port A to Port B via a communication link according to the corresponding send and receive lists of the participating nodes within m successive transmission cycles. In other words, each data message within a so-called isochronous cycle, is sent to the same addressee. Additional data messages can be transmitted within the available timeslots in addition to these m data messages.

In step 31, at least one of these m data messages is selected and associated with a transmission cycle between the Port C and Port D. The selection of the data messages can be deterministic, i.e., for example, the first received data message is always selected.

In step 32, the selected data message(s) is/are transmitted from Port C to Port D according to the applicable send and receive lists within the associated transmission cycle via a low-performance communication link.

FIG. 4 shows the process for the reverse direction:

In step 35, a data message is transmitted from Port D to Port C according to the applicable send and receive lists within a transmission cycle via a low-performance communication link. In step 36, this data message is stored and associated with a transmission cycle between the Port B and the Port A. This can be, for example, the immediately following transmission cycle.

In step 37, the stored data message is transmitted from Port B to Port A according to the applicable send and receive lists within the associated transmission cycle. In step 38, this transmission is repeated during several consecutive transmission cycles. Instead of repeating step 38, replacement messages can also be transmitted.

FIG. 5 shows an embodiment of an automation system with the nodes 41, 42, 43, 44 and 45. The node 41 can be a drive which includes a coupling node with the two Ports “Fast” and one Port “Slow”. The Port “Fast” corresponds to the Port B and the Port “Slow” corresponds to the Port C of the coupling node 1 of FIG. 2.

One Port “Fast” of the node 41 is connected with the Port “Fast” of the node 42, corresponding to the Port A of the node 3 of FIG. 2. The line connecting supports “Fast” of the nodes 41 and 42 represents accordingly a high-performance communication link 46, corresponding to the communication link 16 of FIG. 2.

The other Port “Slow” of the node 41 is connected via a low-performance communication link 47 with a Port “Slow” of the node 43, corresponding to the communication link 12 and the Port D, respectively, of FIG. 2.

In addition, another Port “Fast” is connected with a corresponding Port “Fast” of the node 45, for example a controller, via a high-performance communication link 48. The node 45 has a Port “Slow” which is connected via a low-performance communication link 49 with a corresponding Port “Slow” of the node 44. The node 45 also includes a coupling node of the type depicted in FIG. 2. The configuration of node 44 corresponds to that of node 2 in FIG. 2.

In the automation system of FIG. 2, for example, a data message can be transmitted from node 42 to node 44, although the transmission has to take place via three communication links with different characteristics.

This can also be used for coupling different sub-networks which will be described in more detail with reference to FIG. 6:

The automation system of FIG. 6 includes different sub-networks 50, 51, 52 and 53. The sub-networks 50 to 53 can have different transmission cycles and/or different data rates. Preferably, the transmission cycles of the different sub-networks are synchronized with each other. However, this is not absolutely necessary.

The corresponding communication systems allow the nodes of one of the sub-networks to communicate with each other. However, a communication across the boundaries of the sub-networks can also be established. The nodes 54, 55 and 56 of the sub-networks 50 are then implemented as coupling nodes, with the coupling nodes corresponding, for example, to coupling node 1 of FIG. 2.

In this way, the node 57 of the sub-network 52 and the node 58 of the sub-network 51 can communicate with each other, although the sub-networks 51 and 52 have different transmission cycles and/or different data rates. Accordingly, for example the node 59 of sub-network 53 can communicate with the node 57, with the node 58, or likewise with one of the coupling nodes 54 to 56. Different existing automation systems can thereby be networked into an overall system without having to exchange components of the existing systems.

Preferably, an industrial Ethernet, preferable a Soft Real-time Ethernet or a Real-Time Fast Ethernet with different transmission cycles, meaning different isochronous cycles and/or different data rates, is used as a communication system for the sub-networks. The length of the transmission cycles in the various sub-networks can be, for example, 500 ms, 10 ms and 1 ms. The different transmission rates can be, for example, 100 MB/s, 10 MB/s and 1 MB/s. For the transition from one transmission rate to another, the real-time data are intermediately stored in the corresponding coupling node.

1. Electronic switching circuit for a scalable communication interface (103) between a first communication link (16) having a first transmission cycle (17) of a first length and a second communication link (12) having a second transmission cycle (13) with a second length, with a receive list (5, 7,15,19) for the first transmission cycle (11) and a send list (4, 6,14, 18) for the second transmission cycle (13), wherein a data message (20, 21, 22, 23, 24, 25, 26, 27, 28) received according to the receive list (5, 7,15, 19) is associated with an element of the send list (4, 6,14, 18).

2. Electronic switching circuit according to claim 1 for integration in a device, for example an automation component (100).

3. Electronic switching circuit according to claim 1 or 2 with a standardized connection technique for at least one or more communication interfaces (103), in particular for connecting standardized cable media.

4. Electronic switching circuit according to claim 1, 2 or 3, wherein the scalability of the communication interface refers to its performance and/or usage functionality.

5. Electronic switching circuit according to one of the preceding claims 1 to 4, wherein the communication interface (103) is formed on the basis of a standard protocol functionality, preferably TCP/IP with Ethernet, with or without real-time capability.

6. Electronic switching circuit according to one of the preceding claims 1 to 5, wherein the communication interface (103) is configured for connecting different device components, in particular components for connecting to a Soft Real-Time Ethernet or Isochronous Real-Time Ethernet.

7. Electronic switching circuit according to one of the preceding claims 1 to 6 with a scalable transmission rate, wherein the transmission rate is preferably specified via a planning process or a plug-and-play mechanism.

8. Electronic switching circuit according to one of the preceding claims 1 to 7 with a routing functionality between the communication interfaces (103).

9. Electronic switching circuit according to one of the preceding claims 1 to 8 with a redundancy functionality for setting up two or more redundant communication links by chaining point-to-point connections between the nodes of a communication network.

10. Electronic switching circuit according to one of the preceding claims 1 to 9, wherein the characteristic properties, in particular the transmission rate, can be associated arbitrarily with the communication interface(s) (103).

11. Electronic switching circuit according to one of the preceding claims 1 to 10, wherein the communication interface (103) can be scaled, adjusted and used with respect to its real-time functionality, in particular for Soft Real-Time Ethernet and Isochronous Real-Time Ethernet, and different automation components (100) can be operated with different requirements regarding the performance of a real-time communication link.

12. Electronic switching circuit according to one of the preceding claims 1 to 11, wherein synchronized transmission cycles (13, 17) from the application of automation components (100) can be used for connecting
dynamic drives and fast input/output devices with a small transmission cycle (17) of the first communication link (16) and
a smaller number of dynamic drives with standard input/output devices with a longer transmission cycle (13) of the second communication link (12).

13. Electronic switching circuit according to one of the preceding claims 1 to 12, wherein the first (16) and the second communication link (12) have different transmission rates.

14. Electronic switching circuit according to one of the preceding claims 1 to 13, wherein the first (17) and a second transmission cycle (13) are synchronous and the lengths of the first (17) and the second transmission cycle (13) are identical or are an integer multiple of each other.

15. Electronic switching circuit according to one of the preceding claims 1 to 14, wherein the send list (4, 6,14, 18) is configured for m-fold transmission of a data message (20-28) within m consecutive transmission cycles (13, 17), after the data message (20-28) has been received n-fold during the first transmission cycle (17) according to the receive list (5, 7,15,19).

16. Electronic switching circuit according to claim 15, wherein m>n, if n≧1, preferably n=1.

17. Electronic switching circuit according to claim 16, wherein the data message (20-28) is transmitted only once according to the send list (4, 6, 14, 18) and wherein in addition a plurality of m−1 replacement data messages is transmitted according to the send list (4, 6,14, 18) during the second transmission cycle (13).

18. Electronic switching circuit according to one of the preceding claims 1 to 17, wherein the first (16) and/or the second communication link (12) are bidirectional and a corresponding send list (4, 6,14, 18) and a receive list (5, 7,15, 19) is associated with each of the bidirectional communication links.

19. Electronic switching circuit according to one of the preceding claims 1 to 18, wherein the data message (20-28) represents real-time data.

20. Electronic switching circuit according to one of the preceding claims 1 to 19, wherein the first (16) and the second communication link (12) have an equidistance characteristic.

21. Electronic switching circuit according to one of the preceding claims 1 to 20, wherein the first (16) and the second communication link (12) represent an industrial Ethernet, in particular an Isochronous Real-Time Ethernet (IRTE) or a Soft Real-Time Ethernet (SRTE).

22. Electronic switching circuit according to one of the preceding claims 1 to 21 with several input and/or output ports, each of which have an associated receive (5, 7,15, 19) and/or send list (4, 6,14, 18), and with a coupling field (29) for coupling at least one of the ports with one or several of the other ports.

23. Automation system with several components (41, 42, 43, 44, 45) which are connected with each other via communication links (46, 47, 48, 49), with each of the components (41-45) including an electronic switching circuit according to one of the preceding claims 1 to 22 as an integral component or as an additional device.

24. Automation system with at least one first sub-network (50, 51, 52, 53) with first communication links and with at least one second sub-network (50, 51, 52, 53) with second communication links and with at least one coupling node (54, 55, 56) between the first and second sub-networks (50-53) with an electronic switching circuit according to one of the preceding claims 1 to 22.

25. Automation system according to claim 24 with several coupling nodes (54-59) which are connected with each other through a third sub-network (50).

26. Automation system according to claim 24 or 25, wherein the different sub-networks (50-53) have different transmission cycles and/or transmission rates.

27. Method for setting up a communication interface (103) between a first communication link (16) with a first transmission cycle (14) of a first length and a second communication link (12) with a second transmission cycle (13) of a second length, wherein the first (17) and the second transmission cycle (13) are preferably synchronized with each other, and wherein the first and the second length are preferably identical or an integer multiple of each other, with the following steps:
receiving a data message (20-28) according to a receive list (5, 7, 15, 19) associated with the first transmission cycle (17),
transmitting the data message (20-28) according to a send list (4, 6, 14, 18) associated with the second transmission cycle (13).

28. Method according to claim 27, wherein the first communication link (16) and the second communication link (12) have different transmission rates.

29. Method according to claim 27 or 28, wherein a data message (20-28) is received from a first station of the first communication link (16) during the first transmission cycle (17) and the data message (20-28) is transmitted m-fold within m consecutive transmission cycles (17, 13) to a second station of the second communication link (12).

30. Method according to claim 29, wherein the data message (20-28) is transmitted only once during the second transmission cycle (13, 17) and a replacement data message is transmitted (m−1)-fold during the subsequent second transmission cycles (13, 17).

31. Method according to one of the preceding claims 27 to 30, wherein the data message (20-28) includes real-time data.

32. Method according to one of the preceding claims 27 to 30, wherein the first (16) and the second (12) communication link have an equidistance characteristic.

33. Method according to one of the preceding claims 27 to 32, wherein the first (16) and the second (12) communication link (12) represent an industrial Ethernet, in particular an Isochronous Real-Time Ethernet or a Soft Real-Time Ethernet.

34. Method according to one of the preceding claims 27 to 33, wherein one or more input ports and/or one or more output ports, each having associated therewith a receive list (5, 7,15, 19) and/or a send list (4, 6,14, 18), are coupled via a coupling field (29).

35. Method according to one of the preceding claims 27 to 34, wherein the first (17) and the second transmission cycle (13) do not exhibit a mutual phase shift.

36. Computer program product with means for carrying out a method according to one of the preceding claims 27 to 35, when the computer program executes on an electronic switching circuit or an automation system.
